(19) United States
(12) Patent Application Publication
(10) Pub. No.: US 2015/0084903 A1
(43) Pub. Date: Mar. 26, 2015

(54) TOUCH DISPLAY DEVICE

(71) Applicants: Interface Optoelectronics (Shenzhen) Co., Ltd., Shenzhen (CN); GENERAL INTERFACE SOLUTION LIMITED, Miaoli County (TW)

(72) Inventors: Shang-Ming Tai, MIAOLI COUNTY (TW); Heng-Sheng Chou, MIAOLI COUNTY (TW); Pang-Chiang Chia, MIAOLI COUNTY (TW); Yang-Ching Feng, MIAOLI COUNTY (TW)

(21) Appl. No.: 14/555,699

(22) Filed: Nov. 28, 2014

(30) Foreign Application Priority Data
Nov. 19, 2014 (CN) 201410665590.X

(51) Int. Cl. G06F 3/041

(52) U.S. Cl. CPC G06F 3/041
USPC 345/173

(57) ABSTRACT

The present invention provides a touch display device including four touch pads, the four touch pads forming a large-size touch pad, where each touch pad includes a substrate, an electrode pattern disposed on the substrate, the electrode pattern having a first edge and a second edge which is adjacent to the first edge, a periphery region defined on the substrate, and disposed surrounding the first edge and the second edge of the electrode pattern, a plurality of traces disposed within the periphery region, and a display device disposed on the large-size touch pad.

### BACKGROUND OF THE INVENTION

1. Field of the Invention

The present invention generally relates to touch display device. Specifically speaking, to a touch display device which is put together by a plurality of touch pads.

2. Description of the Prior Art

Nowadays, personal digital assistants (PDA), mobile phones, notebook computers, tablet PCs and other portable electronic products are wildly used in modern life.

Since these electronic products need to be thinner and lighter, the traditional input devices, such as keyboards or mice have to be replaced with other input devices. In addition, the needs for tablet PCs has greatly increased, hence the touch panel technology has become one of the key components in electronic products.

As the demands of the large-size touch pad have increased, the process for forming the large-size touch pad requires higher costs. Therefore, a method to reduce the cost of large-size touch pad is an important research objective.

### SUMMARY OF THE INVENTION

The present invention provides a touch display device comprises four touch pads, the four touch pads forming a large-size touch pad, wherein each touch pad includes a substrate, an electrode pattern disposed on the substrate, the electrode pattern having a first edge and a second edge which is adjacent to the first edge, a periphery region defined on the substrate, and disposed surrounding the first edge and the second edge of the electrode pattern, a plurality of traces disposed within the periphery region, and a display device disposed on the large-size touch pad.

The touch display device of the present invention is formed from four smaller touch pads. Therefore, the manufacturing cost can be reduced since the total cost for forming four smaller touch pads respectively is lower than forming a large-size touch pad directly. In addition, in the present invention, the traces of each touch pad are not arranged between every two adjacent electrode patterns, so the active region of the touch display device will not be shrunk or influenced caused by the traces.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top view diagram showing a conventional touch display device which is put together by a plurality of touch pads.

FIG. 2 is a top view diagram showing the touch display device of the present invention which is put together by a plurality of touch pads.

FIG. 3 is the 3D schematic diagram showing the touch display device of the present invention.

### DETAILED DESCRIPTION

To provide a better understanding of the present invention to users skilled in the technology of the present invention, preferred embodiments are detailed as follows. The preferred embodiments of the present invention are illustrated in the accompanying drawings with numbered elements to clarify the contents and effects to be achieved.

Please note that the figures are only for illustration and the figures may not be to scale. The scale may be further modified according to different design considerations. When referring to the words “up” or “down” that describe the relationship between components in the text, it is well known in the art and should be clearly understood that these words refer to relative positions that can be inverted to obtain a similar structure, and these structures should therefore not be precluded from the scope of the claims in the present invention.

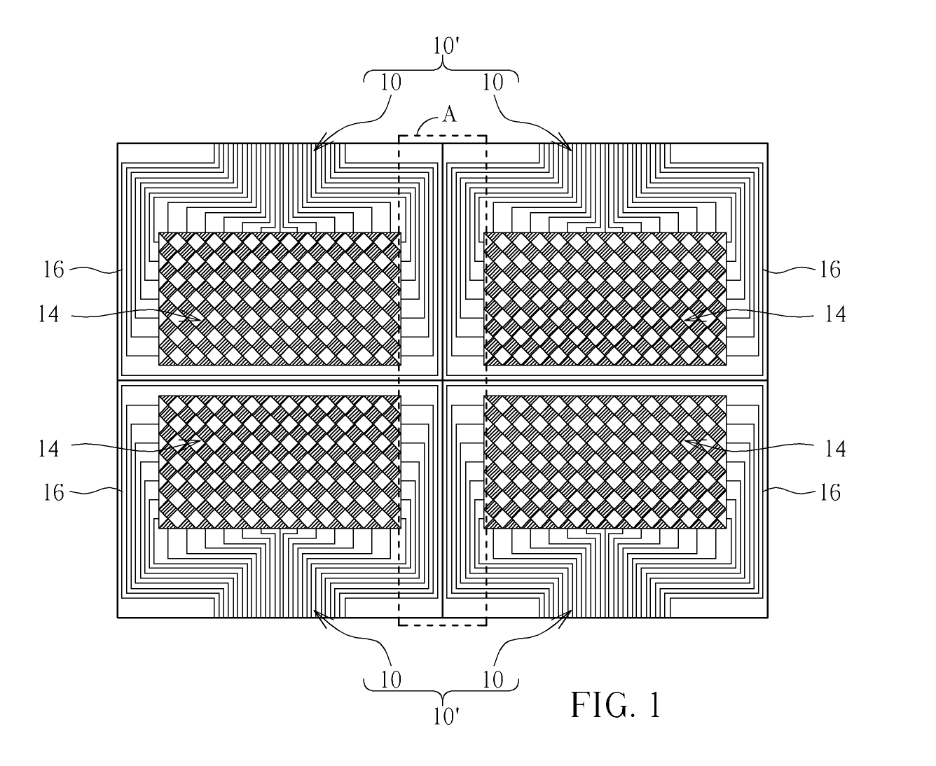

FIG. 1 is a top view diagram showing a conventional touch display device which is put together by a plurality of touch pads. As shown in FIG. 1, in conventional process, in order to reduce the cost, preferably, a plurality of smaller-size touch pads 10 are provided, and afterwards, these smaller-size touch pads 10 are put together into one large-size touch pad. Each smaller-size touch pad 10 comprises a substrate 12, an electrode pattern 14 and a plurality of traces 16 disposed on the substrate 12. After the smaller-size touch pads 10 are put together into a large-size touch pad 10′, a display device (not shown) is then covered on the large-size touch pad 10′, so as to complete the large-size touch display device.

Compared with the method of forming the large-size touch pad directly, the method mentioned above can effectively decrease the manufacturing cost. In other words, the total cost for forming four touch pads and then joining the four touch pads into one large-size touch pad is lower the cost for forming one large-size touch pad directly. However, in conventional process, the trace 16 of each touch pads 10 is usually arranged surrounding the electrode pattern 14 (usually, the traces will arranged along three or more different edges of the electrode pattern), therefore, the trace 16 will usually be disposed within the “putting together region” (which means the region that between every two adjacent electrode patterns after the smaller-size touch pads are put together into one large-size touch pad), and thereby forming some “non-active regions” A. The non-active regions A are accumulated by traces, and do not have touching functions, thereby decreasing the area of the active region of the touch display device.

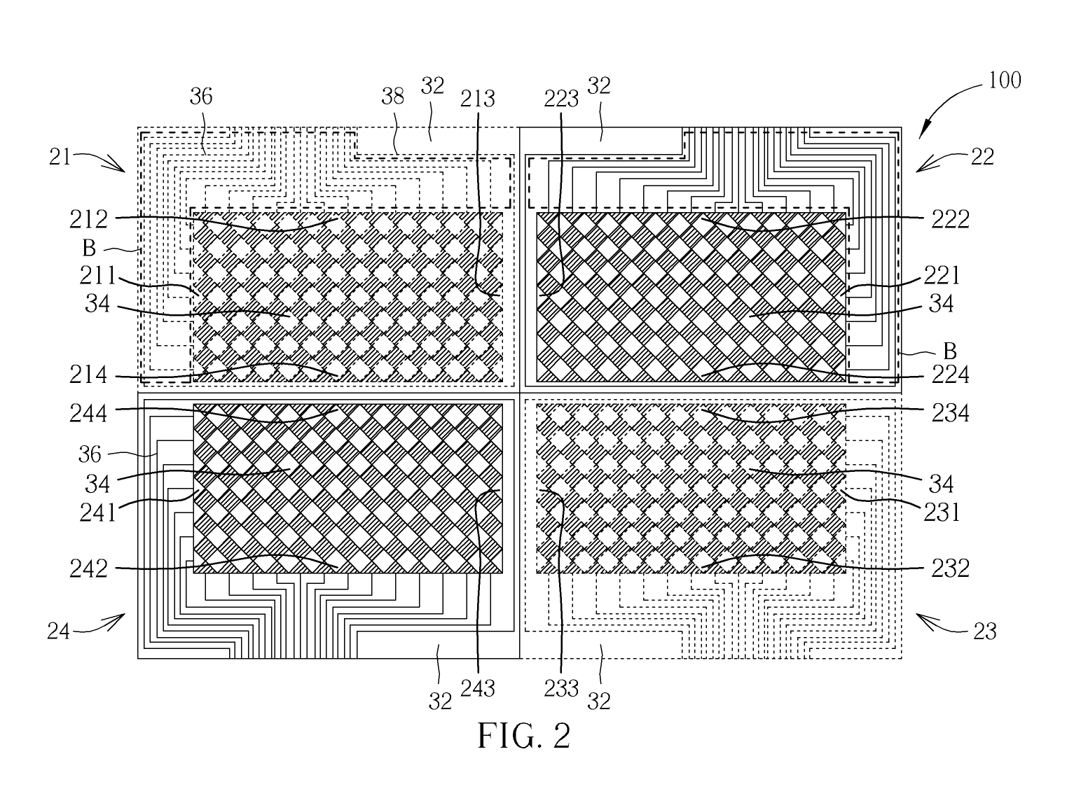

An important feature of the present invention is that the traces of each touch pad are extended from only two different directions of the electrode pattern, and the traces will avoid being disposed within the “putting together region”. More precisely, FIG. 2 is a top view diagram showing the touch display device of the present invention. As shown in FIG. 2, a large-size touch pad 100 is formed from four touch pads: a first touch pad 21, a second touch pad 22, a third touch pad 23 and a fourth touch pad 24. The first touch pad 21 and the third touch pad 23 are arranged diagonally; and the second touch pad 22 and the fourth touch pad 24 are arranged diagonally. Each of the first touch pad 21 to the fourth touch pad 24 comprises a substrate 32, an electrode pattern 34 and a plurality of traces 36 disposed on the substrate 32. The electrode pattern 34 is made of transparent conductive materials, such as indium tin oxide (ITO), and includes a plurality of electrodes arranged along two different directions and crossed to each other. The traces 36 are usually made of materials with high conductivity (such as metals). The methods for forming the electrode pattern 34 and for forming the traces 36 are well known to persons of ordinary skills in the art and the details will not be described here.

It is noteworthy that in this embodiment, the first touch pad 21 has four different edges: a first edge 211, a second edge 212, a third edge 213 and a fourth edge 214. Similarly, the second touch pad 22 has four different edges: a first edge 221, a second edge 222, a third edge 223 and a fourth edge 224. The third touch pad 23 has four different edges: a first edge 231, a second edge 232, a third edge 233 and a fourth edge 234. The fourth touch pad 24 has four different edges: a first edge 241, a second edge 242, a third edge 243 and a fourth edge 244. It is noteworthy that in each touch pad, the first edge is adjacent to the second edge. The substrate 32 of each touch pad (including the first touch pad 21 to the fourth touch pad 24) has a periphery region B defined thereon, and the traces 36 are only disposed within the periphery region B. The periphery region B is only disposed surrounding the first edge and the second edge of each touch pad (including the first touch pad 21 to the fourth touch pad 24), but not disposed surrounding the third edge and the fourth edge of each touch pad. Taking the first touch pad 21 as an example, the traces 36 are only disposed on the substrate 32 surrounding the first edge 211 and the second edge 212. On the other hand, since the periphery region B does not exist on the place surrounding the third edge 213 and the fourth edge 214, the third edge 213 and the fourth edge 214 are closer to the edges of the substrate 32, and the edges of the substrate 32 that are closer to the third edge 213 and the fourth edge 214 can be defined as the “putting together edge” of the first pad 21, which means the putting together edge of one touch pad will directly contact the putting together edge of another touch pad after the large-size touch pad is formed. Similarly, the second touch pad 22, the third touch pad 23, and the fourth touch pad 24 also have the periphery region B defined on the substrates 32 respectively. And the traces 36 of the second touch pad 22, the third touch pad 23, and the fourth touch pad 24 are disposed within their periphery region B too. The edges that are closer to the third edge and the fourth edge can be defined as the putting together edges. In addition, each touch pad may selectively further comprise a shielding line 38 disposed on the substrate 32, surrounding the electrode 34 and the traces 36 of each touch pad, to shield the noise of each touch pad.

The feature of the present invention is that one putting together edge of one touch pad will directly contact one putting together edge of another touch pad after the large-size touch pad is put together. And the traces 36 will not be disposed between every two adjacent electrode patterns 34 after the large-size touch pad is put together. As shown in FIG. 2, the third edge 213 of the first touch pad 21 is put together with the third edge 223 of the second touch pad 22, and the fourth edge 214 of the first touch pad 21 is put together with the fourth edge 244 of the fourth touch pad 24. The third edge 233 of the third touch 23 pad is put together with the third edge 243 of the fourth touch pad 24, and the fourth edge 234 of the third touch pad 23 is put together with the fourth edge 224 of the second touch pad 22. Therefore, after the large-size touch pad is put together, the periphery regions B are only disposed out of and surrounding the formed electrode pattern, but not disposed between every two adjacent electrode patterns. In this way, the non-active region will not be formed between the electrode patterns after the large-size touch pad is formed, thereby increasing the active region of the touch display device.

Besides, in the present invention, the structure of the first touch pad 21 is essentially the same as the structure of the third touch pad 23, and the structure of the second touch pad 22 is essentially the same as the structure of the fourth touch pad 24. In addition, the structure of the first touch pad 21 is essentially the same as the mirrored structure of the second touch pad 22. In other words, in the present invention, the first touch pad 21 to the fourth touch pad 24 only comprise two different arrangement patterns of the electrode patterns and traces (the arrangement pattern mentioned here means the arrangement of the electrode pattern and the traces), and the one of the arrangement pattern is same as the mirrored structure of another arrangement pattern. However, in another embodiment of the present invention, there is only one arrangement pattern that is used. More precisely, a same photomask is used to form four same touch pads, and afterwards, two of these touch pads are overturned. Therefore, the mirrored structure of the arrangement pattern can be easily obtained. Therefore, in actual manufacturing process, the four touch pads can be formed through only one photomask, and then two of the touch pads are overturned, so as to put together the four touch pads into one large-size touch pad. Compared with the method of forming two different arrangement patterns with two different photomasks respectively, this method only use one photomask to form four touch pads, thereby simplifying the manufacturing process.

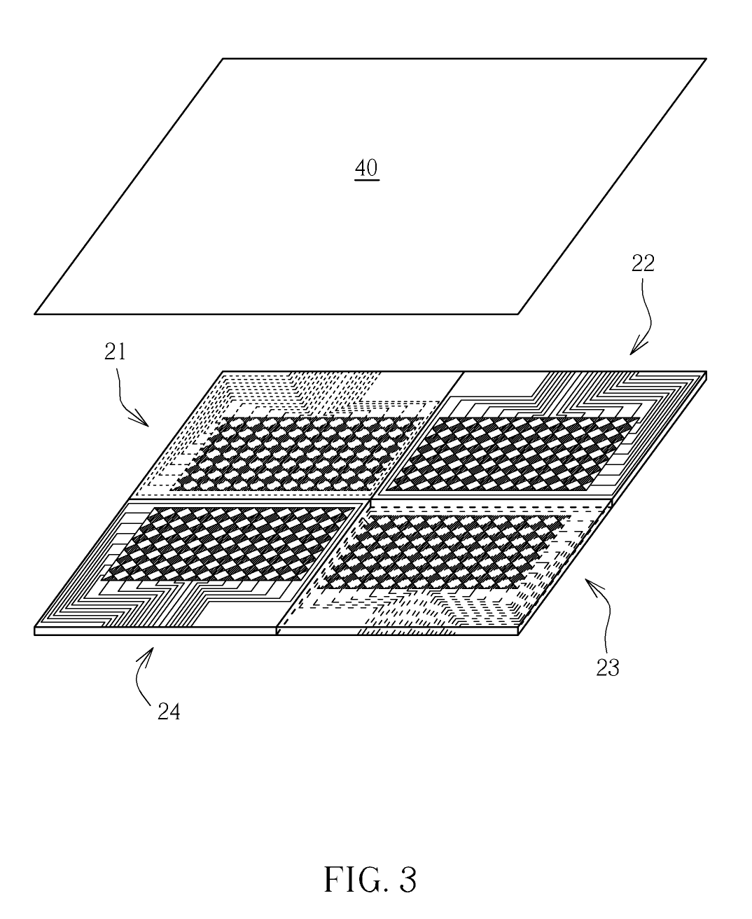

Please refer to FIG. 3, FIG. 3 is the 3D schematic diagram showing the touch display device of the present invention. After the first touch pad 21 to the fourth touch pad 24 are put together and to form the large-size touch pad 100, a display device 40 is then covered on the large-size touch pad 100, such as a liquid crystal display (LCD), but not limited thereto. In the present invention, the display device 40 is preferably a whole piece structure, and it can provide better display performance, but in another embodiment of the present invention, the display device 40 can also be formed from (put together by) a plurality of smaller-size display devices, and this should be included in the scope of the present invention. In addition, as shown in FIG. 3, after the first touch pad 21 to the fourth touch pad 24 are put together and to form the large-size touch pad 100, parts of the electrode patterns and parts of the traces (such as the electrode patterns and the traces of the first touch pad 21 and the third touch pad 23) are disposed on one-side surface of the substrate 32, and parts of the electrode patterns and parts of the traces (such as the electrode patterns and the traces of the second touch pad 22 and the fourth touch pad 24) are disposed on another-side surface of the substrate 32. The present invention has some advantages such as having simple structure, having lower cost and decreasing the difficulties of the manufacturing process.

In summary, the touch display device of the present invention is formed from four smaller touch pads. Therefore, the manufacturing cost can be reduced since the total cost for forming four smaller touch pads respectively is lower than forming a large-size touch pad directly. In addition, in the present invention, the traces of each touch pad are not arranged between two adjacent electrode patterns, so the active region of the touch display device will not be shrunk or influenced caused by the traces.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display device, comprising:
four touch pads, the four touch pads forming a large-size touch pad, wherein each touch pad comprises:
a substrate, an electrode pattern disposed on the substrate, the electrode pattern having a first edge and a second edge which is adjacent to the first edge, a periphery region defined on the substrate, and disposed surrounding the first edge and the second edge of the electrode pattern; and
a plurality of traces disposed within the periphery region;
and a display device disposed on the large-size touch pad.

2. The touch display device of claim 1, wherein the four touch pads comprise: a first touch pad, a second touch pad, a third touch pad and a fourth touch pad, the structure of the first touch pad is essentially the same as the structure of the third touch pad, and the structure of the second touch pad is essentially the same as the structure of the fourth touch pad.

3. The touch display device of claim 2, wherein the structure of the first touch pad is essentially the same as the mirrored structure of the second touch pad.

4. The touch display device of claim 2, wherein the first touch pad and the third touch pad are arranged diagonally.

5. The touch display device of claim 2, wherein each electrode pattern has a third edge and a fourth edge, the third edge of the first touch pad being put together with the third edge of the second touch pad, and the fourth edge of the first touch pad being put together with the fourth edge of the fourth touch pad.

6. The touch display device of claim 5, wherein the third edge of the third touch pad is put together with the third edge of the fourth touch pad, and the fourth edge of the third touch pad is put together with the fourth edge of the second touch pad.

7. The touch display device of claim 5, wherein the periphery region is not disposed surrounding the third edge and the fourth edge of each electrode pattern.

8. The touch display device of claim 1, wherein each touch pad further comprises a shielding trace disposed on the substrate, and the shielding trace surrounds the traces and the electrode pattern of each touch pad.
